(19) United States
(12) Patent Application Publication
(10) Pub. No.: US 2010/0130670 A1
(43) Pub. Date: May 27, 2010

(54) END USE APPLICATIONS PREPARED FROM CERTAIN BLOCK COPOLYMERS

(75) Inventors: RICHARD GELLES, Houston, TX (US); KATHRYN WRIGHT, Katy, TX (US); RUIDONG DING, League City, TX (US)

Correspondence Address: KRATON POLYMERS U.S. LLC, 16400 Park Row, HOUSTON, TX, 77084, US

(73) Assignee: KRATON POLYMERS US LLC, Houston, TX (US)

(21) Appl. No.: 12/275,353

(22) Filed: Nov. 21, 2008

(51) Int. Cl. C08L 69/00; C08L 67/00; C08L 77/06; C08L 53/02

(52) U.S. Cl. 524/537; 525/418; 525/419; 525/88; 524/539; 525/94; 524/599; 524/538

(57) ABSTRACT

Articles and methods for forming articles containing hybrid block copolymers having conjugated diene and/or alkenyl aromatic and at least one block of (1-methyl-1-alkyl)alkyl ester groups and/or anhydride groups which are derived from the ester groups and/or acid groups.

### BACKGROUND OF THE INVENTION

1. Field of the Invention

This invention relates to various compositions and end use applications prepared from certain hybrid block copolymers having (1-methyl-1-alkyl)alkyl ester groups and/or anhydride groups which are derived from the ester groups and/or acid groups which are derived from the ester groups. The invention also relates to formed articles and methods for forming articles from such hybrid block copolymers.

2. Background of the Art

Elastomeric polymers, both homopolymers and polymers of more than one monomer, are well known in the art. A particularly useful class of synthetic elastomers is the class of thermoplastic elastomers which demonstrates elastomeric properties at ambient temperatures but which is processable at somewhat elevated temperatures by methods more conventionally employed for non-elastomeric thermoplastics. Such thermoplastic elastomers are illustrated by a number of types of block polymers including, for example, block polymers of alkenyl aromatic compounds and conjugated dienes. Block polymers of styrene and butadiene are illustrative.

The properties of block polymers, even containing the same or similar monomers, will vary considerably with the arrangement of the monomeric blocks within the block polymer and with the relative molecular weight of each block. It is also known that certain of the properties such as resistance to oxidation of this class of block polymers are improved by the selective hydrogenation of some or all of the carbon-carbon unsaturation in the polyalkadiene or aliphatic portion of the molecule and, on occasion, by the hydrogenation of substantially all the carbon-carbon unsaturation including that unsaturation in the poly(alkenyl aromatic compound) or aromatic portion of the molecule. A number of the selectively hydrogenated block polymers are also well known and commercially available, such as KRATON® G block copolymers.

An alternate method of modifying selected properties of the block polymers is to provide polarity or functionality within the block polymer as by introducing functional groups as substituents within the molecule or by providing one or more additional blocks within the polymeric structure which are polar in character. Such polymers included maleated block copolymers, such as KRATON® FG block copolymers. These polymers are made by free radical grafting processes where the maleic anhydride functionality is chemically grafted onto the hydrogenated alkadiene block.

It is well known in the art to use polar, low modulus, elastomers to modify, and especially to impact modify, engineering thermoplastics, for example as described in U.S. Pat. No. 4,174,358. Furthermore, the use of styrenic block copolymers which contain anhydride functionality to modify engineering thermoplastics is also known, for example as disclosed in U.S. Pat. No. 5,272,208.

However, maleated block copolymers suffer from several drawbacks. First, the styrene block of the block copolymer is necessarily limited because a smaller styrene block is required for processability. This can affect certain properties, for example, heat resistance, and in particular, resistance to compression set at elevated temperature. As a result, the commercial acid-functionalized block copolymers made by free radical extrusion processes have not found large commercial use in certain applications. Second, commercial acid-functionalized block copolymers made by any free radical process such as melt grafting, solution grafting or fluidized bed liquid or gas phase grafting may contain low molecular weight by-products of the free radical process which may also lead to reduced heat resistance, and in particular, reduced resistance to compression set at elevated temperature.

Third, commercial acid-functionalized block copolymer made by any free radical process are limited in functionality level, as high levels of melt grafted functionality (>2%) often lead to poor color.

Fourth, commercial acid-functionalized polymers made by free radical grafting processes have a large percentage of molecules with several functional groups widely separated on the molecule so that if they are combined with reactive materials crosslinking results which affects phase size, harms mechanical properties, and reduces processability of the final composition.

Also known are functionalized block copolymer formed by anionic polymerization rather than free radical grafting processes and have the functionality in a well defined block. U.S. Pat. No. 5,194,510 and U.S. Pat. No. 5,278,245 disclose block copolymers that contain blocks of polymerized alkyl methacrylates and blocks of t-butyl methacrylate (TBMA). These blocks of t-butyl methacrylate are reactive. U.S. Pat. No. 5,338,802 discloses reaction of the t-butyl methacrylate blocks with amines to form amides or imides. U.S. Pat. No. 5,218,053 discloses a novel polymer that contains anhydride rings. The anhydride rings are prepared by thermally decomposing adjacent units of (1-methyl-1-alkyl)alkyl esters such as in a poly(t-butylmethylacrylate) block. This thermal reaction forms predominately a six-membered glutaric anhydride ring in addition to some carboxylic acid groups. In the case of low reaction conversion, unreacted ester groups may also be present. In addition, the anhydride rings will form at least some carboxylic acid groups upon contact with water. Accordingly, the resulting polymer may contain ester, anhydride and acid groups and are referred to as hybrid block copolymers. These functional groups provide polarity and reactivity to the block copolymer. A number of polymers were disclosed in U.S. Pat. No. 5,218,053 having the anhydride rings in the polymer backbone. Copending U.S. application Ser. No. 12/248,184 discloses the reaction product of the hybrid block copolymer of U.S. Pat. No. 5,218,053 with reactive resins, monomers, and metal derivatives in adhesives, sealants, coatings, and printing plate applications.

Polymers containing functional groups, including polyolefins, styrenic polymers, and styrenic block copolymers by free radical grafting have been used to help disperse, or improve adhesion between, an organic polymeric material and reinforcing materials, pigments, flame retardants and other formulating ingredients. Improving dispersion and or adhesion between an organic phase such as a polymer composition and inorganic or organic reinforcing materials, pigments and flame retardants often improves properties for example higher tensile strength, retention of strength after exposure to or immersion in water, smoother surface appearance, lower stress relaxation and lower creep. Additionally, the use of a polyolefin containing functional groups can help exfoliate clays in a polymeric composition so that performance improves, for example stiffness and gas barrier properties. Good wetting of polymeric compositions to fibers can be used to align and orient the fibers to further improve performance including stiffness and heat distortion temperature. The addition of pigments and flame retardants would be improved if the composition contains polymers which act as wetting or dispersing aids.

Examples include U.S. Pat. No. 7,371,793 which discloses compositions comprising organo clay and functionalized polyolefins, and U.S. Pat. No. 7,323,504 which discloses compositions comprising polyamides, a non-halogen flame retardant, and a maleic anhydride modified olefin copolymer. Additionally, U.S. Pat. No. 7,329,708 discloses a curable PPE composition containing a styrene-maleic anhydride copolymer adhesion promoter.

However, there is a need for functionalized polymers which are compatible or react with certain organic polar polymeric materials or can be used to help disperse and improve adhesion between certain organic polymeric materials and reinforcing materials (including fillers and fibers), pigments and flame retardants. Functionalized polyolefins made by free radical grafting often cannot be used in certain systems if they are not compatible or cannot react with the polymers in the system. For example, these functionalized polyolefins are not compatible with styrenic polymers like polystyrene, styrene-maleic anhydride copolymers, styrene-acrylic monomer copolymers, and are not compatible with PPE. Also, styrenic polymers with functional groups such as styrene-maleic anhydride copolymers are not fully compatible with styrenic polymers and PPE except if the co-monomer content, for example maleic anhydride, is low. As described above, functionalized styrenic block copolymers made by free radical extruder grafting have several drawbacks. What is needed therefore are polymers without these drawbacks which are functionalized as well as compatible in the various systems and/or improve dispersability.

### SUMMARY OF THE INVENTION

The multiple embodiments of the present invention avoid the drawbacks of commercial acid-functionalized block copolymers and take advantage of the improved performance of functionalized block copolymers formed by anionic polymerization.

It has been discovered herein that functionalized block copolymers with the functionality in a well defined block will be more efficient in many cases than polymers made by free radical grafting at compatibilization and dispersion of polar polymers and fillers. Compatibilization is often defined practically as an improvement in a property for example strength, toughness, or clarity. Compatibilization usually results from either an improved dispersion or smaller phase size of the block copolymer and another ingredient such as a polar polymer or filler aggregate, or from improved adhesion between the block copolymer and another ingredient such as a polar polymer or filler aggregate.

The hybrid block copolymers of the present invention can contain blocks with controlled molecular weight of styrene, conjugated diene, and (1-methyl-1-alkyl)alkyl ester groups and/or anhydride groups which are derived from the ester groups and/or acid groups which are derived from the ester groups. For example, a Polystyrene-polyTBMA or Polystyrene-hydrogenated polybutadiene-polyTBMA block polymer can be made which will be compatible and adhere well to polystyrene, PPE, high impact polystyrene and will help disperse and improve adhesion with fillers, fibers, pigments, flame retardants and the like. The styrene block of the hybrid block copolymer gives compatibility with styrenics and PPE, the conjugated diene block of the hybrid block copolymer gives compatibility with polyolefins, and the block of (1-methyl-1-alkyl)alkyl ester groups and/or anhydride groups which are derived from the ester groups and/or acid groups which are derived from the ester groups gives compatibility and or reactivity with polymers with polar and reactive groups such as polyamides, polyesters, polyurethanes and the like.

In addition the hybrid block copolymers show improved adhesion, better wetting, and better dispersing capability for fillers, fibers, pigments, flame retardants, etc. than block copolymers which contain functional groups which are made by free radical grafting processes.

The hybrid block copolymer compositions of the present invention offer performance advantages compared to compositions with functionalized polyolefin waxes, styrenic polymers and functionalized block copolymers made by free radical grafting. The performance advantages of hybrid block copolymer compositions include, for example, improved abrasion resistance, improved resistance to compression set at elevated temperature, improved flexural modulus and tensile strength, and an improved balance of stiffness, impact resistance and heat distortion temperature.

In some embodiments, the present invention may be an article comprising at least one engineering thermoplastic resin and a hybrid block copolymer, said hybrid block copolymer having at least one A block or B block copolymerized with at least one M block, the A block is a polymer block of one or more mono alkenyl arenes and the B block is a polymer block of at least one or more conjugated dienes; the M block is an ester or anhydride polymer block of (1-methyl-1-alkyl)alkyl ester; the A block having a molecular weight range of from 500 to 40,000, and the B block having a molecular weight range of from 2,000 to 200,000 and the M block having a molecular weight from 200 to 100,000 prior to optional conversion to anhydride form.

The above article may contain at least one engineering thermoplastic resin selected from the group consisting of thermoplastic polyesters, thermoplastic polyurethanes, poly(aryl ethers), poly(aryl sulfones), polycarbonates, acetal resins, polyamides, halogenated thermoplastics, nitrile barrier resins, acrylic polymers, and cyclic olefin copolymers, and mixtures thereof. In further embodiments, the engineering thermoplastic resin comprises a poly(aryl ether) and at least one other of said engineering thermoplastic resins. In still further embodiments, the poly(aryl ether) is polyphenylene ether.

In other embodiments the at least one engineering thermoplastic resin may be a polyamide. In further embodiments, the polyamide may be selected from the group consisting of polyhexamethylene adipamide (nylon 6,6), polyhexamethylene sebacamide (nylon 6,10), polycaprolactam (nylon 6), polyhexamethylene terephthalamide, polyhexamethylene isophthalamide, polyhexamethylene tere-co-isophthalamide, and mixtures thereof In other embodiments the article may comprise a polyolefin and a poly(aryl ether). In still other embodiments, the conjugated diene of the hybrid block copolymer is butadiene or isoprene, the mono alkenyl arene is styrene, and the (1-methyl-1-alkyl)alkyl ester is tert-butyl methacrylate. The article of claim 1 containing from 2-40% of the hybrid block copolymer and from 4-98% of the at least one engineering thermoplastic resin. Additionally, the article may comprise optionally hydrogenated styrenic block copolymers.

In some embodiments the article is selected from the group consisting of injection molded/extruded articles, packaging films, barrier films, personal hygiene films and fibers, blown films, coextruded films, tie layers, medical devices, toys, extruded films, extruded tubes, extruded profiles, overmolded grips, overmolded parts, airbags, steering wheels, toys, cap seals, automotive parts, spray coatings, trays, gloves, gaskets, sheets, athletic equipment, and hoses/tubing.

In some embodiments the article is in the form of a film, sheet, coating, band, strip, profile, molding, foam, tape, fabric, thread, filament, ribbon, fiber, plurality of fibers or fibrous web.

In some embodiments the article is formed in a process selected from the group consisting of injection molding, over molding, dipping, extrusion, roto molding, slush molding, fiber spinning, film making or foaming.

In still other embodiments, the present invention may be an article comprising a paraffinic or naphthenic extending oil and a hybrid block copolymer, said hybrid block copolymer comprising at least one A block or B block copolymerized with at least one M block, wherein the A block is a polymer block of one or more mono alkenyl arenes and the B block is a polymer block of at least one or more conjugated dienes; the M block is an ester or anhydride polymer block of (1-methyl-1-alkyl)alkyl ester; the A block having a molecular weight range of from 500 to 40,000, and the B block having a molecular weight range of from 2,000 to 200,000 and the M block having a molecular weight from 200 to 100,000 prior to optional conversion to anhydride form.

In additional embodiments, the article may further comprise an olefin polymer selected from the group consisting of ethylene homopolymers, ethylene/alpha olefin copolymers, ethylene/vinyl aromatic copolymers, propylene homopolymers, propylene/alpha olefin copolymers, propylene/vinyl aromatic copolymers, high impact polypropylene, and ethylene/vinyl acetate copolymers. In additional embodiments, the article may also comprise a styrene polymer selected from the group consisting of crystal polystyrene, high impact polystyrene, medium impact polystyrene, and syndiotactic polystyrene.

### DETAILED DESCRIPTION OF THE INVENTION

The multiple embodiments of the present invention include the hybrid block copolymer composition as defined above. The process for making the starting base block copolymer is described and claimed in the U.S. Pat. No. 5,218,053, which disclosure is herewith incorporated by reference.

As used herein, the term “hybrid block copolymer” refers to a block copolymer composition comprising at least one block of a polymerized conjugated diene (or hydrogenated version) or a polymerized alkenyl aromatic and at least one end block comprising polymerized alkyl methacrylates, polymerized t-butyl methacrylate, a block of anhydride rings that is prepared by thermally decomposing adjacent units of (1-methyl-1-alkyl)alkyl esters such as in a poly(t-butylmethylacrylate) block, or a block with a repeat unit of a six membered anhydride ring, i.e. glutaric anhydride, (or a reaction product of a six membered anhydride ring with water to form the corresponding carboxylic acid).

The base polymers according to multiple embodiments of the present invention prior to formation of the anhydride rings or blending with other ingredients are exemplified by the following structures:

| | |
|---|---|
| A-M | I |
| B-M | II |
| B-M-B | III |
| M-B-M | IV |
| (B-M-)_{y}-X | V |
| (M-B-)_{y}-Z | VI |
| A-B-M | VII |
| B-A-M | VIII |
| A-B-A′-M | IX |
| M-A-B-A′-M | X |
| (A-B-M-)_{y}-X | XI |
| (M-A-B-)_{y}-Z | XII |
| (M-B-A-)_{y}-Z | XIII |
| (A-M-)_{y}-X | XIV |
| (M-A-)_{y}-Z | XV |

wherein each A and A′ is a block or segment comprising predominantly a polymerized mono alkenyl arene, each B is a block or segment comprising predominantly a polymerized conjugated diene, each M is a segment or block comprising at least two adjacent units of a polymerized (1-methyl-1-alkyl)alkyl ester, y is an integer representing multiple arms in a star configuration, X is the residue of a polyfunctional coupling agent, and Z is a crosslinked core of a polyfunctional coupling agent or a polyfunctional polymerization initiator.

The alkenyl aromatic compound employed as each A and A′ block or segment in some of the above structures is a hydrocarbon compound of up to 18 carbon atoms having an alkenyl group of up to 6 carbon atoms attached to a ring carbon atom of an aromatic ring system of up to 2 aromatic rings. Such alkenyl aromatic compounds are illustrated by styrene, 2-butenylnaphthalene, 4-t-butoxystyrene, 3-isopropenylbiphenyl, and isopropenylnaphthalene. The preferred alkenyl aromatic compounds have an alkenyl group of up to 3 carbon atoms attached to a benzene ring as exemplified by styrene and styrene homologs such as styrene, α-methylstyrene, p-methylstyrene, and α,4-dimethylstyrene. Also included are monomers such as 1,1-diphenylethylene monomer, 1,2-diphenylethylene monomer, and mixtures thereof. Styrene and α-methylstyrene are particularly preferred alkenyl aromatic compounds, especially styrene.

Each A and A′ block or segment of the polymers is preferably at least 80% by weight polymerized alkenyl aromatic compound and is most preferably a homopolymer.

Each B block or segment in the structures of Formula II-XIII preferably comprises at least 90% by weight of the polymerized conjugated alkadiene. Most preferably, the B segments or blocks are homopolymers or copolymers of one or more conjugated alkadienes. The conjugated alkadienes preferably have up to 8 carbon atoms. Illustrative of such conjugated alkadienes are 1,3-butadiene(butadiene), 2-methyl-1,3-butadiene(isoprene), 1,3-pentadiene(piperylene), 1,3-octadiene, and 2-methyl-1,3-pentadiene. Preferred conjugated alkadienes are butadiene and isoprene, particularly butadiene. Within the preferred polyalkadiene blocks or segments of the polymers of Formula II-XIII, the percentage of units produced by 1,4 polymerization is at least about 5% and preferably at least about 20%. In addition, copolymers of conjugated dienes and alkenyl aromatics are also included, where the structure may be a random copolymer, a tapered copolymer or a controlled distribution block copolymer. Controlled distribution block copolymers are disclosed in U.S. Pat. No. 7,169,848, which disclosure is herein incorporated by reference.

Each M is preferably a methacrylate block or segment comprising at least two adjacent units of a polymerized (1-methyl-1-alkyl)alkyl methacrylate. Homopolymeric M segments or blocks of (1-methyl-1-alkyl)alkyl methacrylates are most preferred.

Each B segment or block has a molecular weight from 2,000 to 500,000 prior to any coupling, preferably from 5,000 to 350,000, and more preferably from 10,000 to 200,000. Each A block has a molecular weight from 500 to 40,000 prior to any coupling, preferably from 1,000 to 20,000, and still more preferably from 5,000 to 15,000. Each non-coupled M segment or block has a molecular weight from 200 to 100,000, preferably from 1,000 to 70,000, more preferably from preferably from 10,000 to 30,000, prior to conversion to an anhydride.

The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, are converted to true molecular weights except when the text points out that the molecular weights are given as styrene equivalent molecular weights, and are commonly referred to as “peak molecular weights”.

The alkyl esters have the following structure:

Monomer:

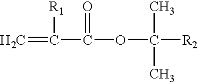

Anhydride Ring

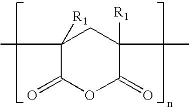

Reaction of ester to anhydride

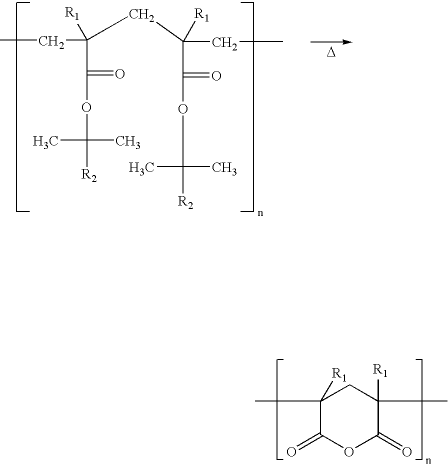

wherein R₁ is hydrogen or an alkyl or aromatic group comprising from 1 to 10 carbon atoms and R₂ is an alkyl group comprising from 1 to 10 carbon atoms.

Adjacent (1-methyl-1-alkyl)alkyl ester groups thermally convert to stable anhydride rings having six members after reaction, ie a glutaric anhydride (GA).

Examples of the (1-methyl-1-alkyl)alkyl esters include:
1,1-dimethylethylacrylate(t-butylacrylate),
1,1-dimethylpropylacrylate(t-pentylacrylate),
1,1-dimethylethyl-α-propylacrylate,
1-methyl-1-ethylpropyl-α-butylacrylate,
1,1-dimethylbutyl-α-phenylacrylate,
1,1-dimethylpropyl-α-phenylacrylate(t-pentylatropate),
1,1-dimethylethyl-α-methylacrylate, (t-butylmethylacrylate), and
1,1-dimethylpropyl-α-methylacrylate (t-pentylmethacrylate).

The most preferred alkyl ester is t-butylmethacrylate which is commercially available in high purity from Mitsubishi-Rayon, Japan. Another source of high purity monomer can be obtained from BASF. Mixture of the alkyl esters of above and other esters, which do not thermally convert to anhydride groups, preferably isobutylmethylacrylate (3-methylpropyl-α-methylacrylate), can be used if M blocks having both ester and anhydride functional groups are desired. Alternatively, the anhydride reaction temperature and residence time can be reduced to afford a mixed block of unreacted ester and six-membered anhydride.

In producing the polymers of Formula I-XV the ester groups may have a tendancy to undergo side reactions with polymer lithium species. In the process of producing a more conventional polymer, e.g., a block polymer of styrene and 1,3-butadiene, a variety of process schemes are available. Such procedures include the production by anionic polymerization of a living polymer of either type of monomer before crossing over to the polymerization of the other type of monomer. It is also conventional to produce such block polymers by sequential polymerization or by the use of coupling agents to obtain branched or radial polymers. In the production of the polymers of the invention, the aliphatic and aromatic portions are produced by sequential polymerization and the ester block is then produced as a final polymerization step prior to termination or any addition of coupling agents.

In each procedure to form a polymer of Formulas I-XV the monomers are anionically polymerized in the presence of a metal alkyl initiator, preferably an alkali metal alkyl. The use of such initiators in anionic polymerizations is well known and conventional. A particularly preferred initiator is sec-butyllithium.

The polymerization of the alkenyl aromatic compounds takes place in a non-polar hydrocarbon solvent such as cyclohexane or in mixed polar/non-polar solvents, e.g., mixtures of cyclohexane and an ether such as tetrahydrofuran or diethyl ether. Suitable reaction temperatures are from about 20° C. to about 80° C. and the reaction pressure is sufficient to maintain the mixture in the liquid phase. The resulting product includes a living poly(alkenyl aromatic compound) block having a terminal organometallic site which is used for further polymerization.

The polymerization of the conjugated alkadiene takes place in a solvent selected to control the mode of polymerization. When the reaction solvent is non-polar, the desired degree of 1,4 polymerization takes place whereas the presence of polar material in a mixed solvent results in an increased proportion of 1,2 polymerization. Polymers resulting from about 6% to about 95% of 1,2 polymerization are of particular interest. In the case of 1,4 polymerization, the presence of ethylenic unsaturation in the polymeric chain results in cis and trans configurations. Polymerization to give a cis configuration is predominant. Polymerization of the esters takes place in the mixed solvent containing the polymerized conjugated alkadiene at a temperature from about −80° C. to about 100° C., preferably from about 10° C. to about 50° C.

Subsequent to production of the acrylic block or segment, the polymerization is terminated by either reaction with a protic material, typically an alkanol such as methanol or ethanol or with a coupling agent. A variety of coupling agents is known in the art and can be used in preparing the coupled block copolymers of the present invention. These include, for example, dihaloalkanes, silicon halides, siloxanes, multifunctional epoxides, silica compounds, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. Nos. 3,985,830; 4,391,949; and 4,444,953; as well as Canadian Patent No. 716,645, each incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin. Coupling with a polymerizable monomer such as divinylbenzene does not terminate the polymerization reaction. Termination to remove the lithium is preferred after coupling with divinylbenzene although additional arms can be grown from the lithium sites before termination if desired. The polymers are then recovered by well known procedures such as precipitation or solvent removal.

The polymers produced by the above procedures will undergo some coupling through an ester group on an adjacent living molecule prior to termination unless the living polymer chains are first end-capped with a unit of 1,1-diphenylethylene or α-methylstyrene. Ester coupling occurs in about 10-50% of the polymer by weight if left unchecked. Such coupling is often acceptable, particularly when the desired polymer structure requires coupling after polymerization of the esters.

The production of the polymers of Formula IV and X is somewhat different procedurally, although the process technology is broadly old. In this modification, conjugated alkadiene is polymerized in the presence of a difunctional initiator, e.g., 1,3-bis(1-lithio-1,3-dimethylpentyl)benzene, to produce a living polyalkadiene species with two reactive organometallic sites. This polymer species is then reacted with the remaining monomers to produce the indicated structures.

The production of the polymers of Formula VI, XII, and XIII and XV is also different procedurally, although the process technology again is broadly old. In this modification, a multifunctional initiator identified as core Z is first produced by anionically polymerizing small molecules of living polystyrene or a living conjugated alkadiene and coupling the small molecules with divinylbenzene to provide numerous organometallic sites for further polymerization.

In a preferred embodiment, the hybrid block copolymers are prepared by a process comprising the steps of:
(a) anionically polymerizing a conjugated alkadiene or an alkenyl aromatic compound to form living polymer molecules;
(b) anionically polymerizing a methacrylic or acrylic monomer bearing a (1-methyl-1-alkyl)alkyl ester to form adjacent units of the ester on the living polymer molecules;
(c) recovering the polymer molecules;
(d) optionally heating the polymer molecules to convert at least some of the adjacent ester groups to anhydride rings (the process of (c) may provide sufficient heat to convert the ester groups to anhydride or the process of (e) combining the hybrid block copolymer with other ingredients may provide sufficient heat to convert the ester group to anhydride;
(e) optionally combining the polymer molecules with other ingredients including plasticizers, flow promoters, oils, resins, polymers, plastics, elastomers fillers, fibers, pigments and the like.

In a further modification of the base polymers of Formula II-XIII used in the invention, the base polymers are selectively hydrogenated to reduce the extent of unsaturation in the aliphatic portion of the polymer without substantially reducing the aromatic carbon-carbon unsaturation of any aromatic portion of the block copolymer. However, in some cases hydrogenation of the aromatic ring is desired. Thus, a less selective catalyst will work.

In a further preferred embodiment, the hybrid block copolymer structures above may be selectively hydrogenated prior to heating to form the anhydride rings and/or blending with other ingredients. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

A number of catalysts, particularly transition metal catalysts, are capable of selectively hydrogenating the aliphatic unsaturation of a copolymer of an alkenyl aromatic compound and a conjugated alkadiene, but the presence of the M segment or block can make the selective hydrogenation more difficult. To selectively hydrogenate the aliphatic unsaturation it is preferred to employ a “homogeneous” catalyst formed from a soluble nickel or cobalt compound and a trialkylaluminum. Nickel naphthenate or nickel octoate is a preferred nickel salt. Although this catalyst system is one of the catalysts conventionally employed for selective hydrogenation absent alkyl methacrylate blocks, other “conventional” catalysts are not suitable for selective hydrogenation of the conjugated alkadienes in the ester containing polymers.

In the selective hydrogenation process, the base polymer is reacted in situ, or if isolated is dissolved in a suitable solvent such as cyclohexane or a cyclohexane-ether mixture and the resulting solution is contacted with hydrogen gas in the presence of the homogeneous nickel or cobalt catalyst. Hydrogenation takes place at temperatures from about 25° C. to about 150° C. and hydrogen pressures from about 15 psig to about 1000 psig. Hydrogenation is considered to be complete when at least about 90%, preferably at least 98%, of the carbon-carbon unsaturation of the aliphatic portion of the base polymer has been saturated, as can be determined by nuclear magnetic resonance spectroscopy. Under the conditions of the selective hydrogenation no more than about 5% and preferably even fewer of the units of the A and A′ blocks will have undergone reaction with the hydrogen. The selectively hydrogenated block polymer is recovered by conventional procedures such as washing with aqueous acid to remove catalyst residues and removal of the solvent and other volatiles by evaporation or distillation.

The anhydride groups in the polymers of the invention are produced by heating the base polymers to a temperature in excess of 180° C., preferably 220° C. to 260° C. Heating is preferably conducted in an extruder having a devolatilization section to remove the volatile by-products formed by combination of two adjacent ester groups to make one anhydride group.

The polymers preferably have the following number average molecular weights after conversion to anhydride as measured by gel permeation chromatography:

| | Preferred Range | | Most Preferred | |
|---|---|---|---|---|
| Formula | Min. MWₙ | Max. MWₙ | Min. MWₙ | Max. MWₙ |
| I | 1,000 | 500,000 | 1,000 | 100,000 |
| II | 1,000 | 1,000,000 | 1,000 | 500,000 |
| III | 1,000 | 2,000,000 | 1,000 | 500,000 |
| IV | 1,000 | 2,000,000 | 1,000 | 500,000 |
| V | 1,000 | 2,000,000 | 1,000 | 1,000,000 |
| VI | 1,000 | 2,000,000 | 1,000 | 500,000 |
| VII | 1,000 | 2,000,000 | 20,000 | 1,000,000 |
| VIII | 1,000 | 2,000,000 | 20,000 | 2,000,000 |
| IX | 1,000 | 2,000,000 | 35,000 | 2,000,000 |
| X | 1,000 | 2,000,000 | 1,000 | 650,000 |
| XI | 1,000 | 2,000,000 | 1,000 | 1,000,000 |
| XII | 1,000 | 2,000,000 | 1,000 | 1,000,000 |
| XIII | 1,000 | 2,000,000 | 1,000 | 1,000,000 |
| XIV | 1,000 | 2,000,000 | 1,000 | 200,000 |
| XV | 1,000 | 2,000,000 | 1,000 | 1,000,000 |

Both absolute and number average molecular weights are determined by conventional GPC as described in the examples below.

While the hybrid polymers containing predominately anhydride or acid groups may be used, they can also be used in the ester form, in other words a polymer with a terminal block of a (1-methyl-1-alkyl)alkyl ester such as t-butylmethylacrylate can be blended with other ingredients either forming the anhydride or acid during the blending process or not. In any case the range of content of the M block may vary, as shown below. The sum of the ester, anhydride and acid forms will equal 100 wt %:

| | Wt. % Ester | Wt. % Anhydride | Wt. % Acid |
|---|---|---|---|
| Broad Range | 0 to 100% | 0 to 100% | 0 to 100% |
| Preferred Range | 0 to 20% | 50 to 100% | 0 to 50% |

### Hybrid Block Copolymer Compositions

Depending on the particular application, for example those in Table B, the hybrid block copolymer composition may comprise additional components. Some of these additional components include engineering thermoplastic resins, styrenic block copolymers, olefin polymers, styrene polymers, plasticizers including paraffinic and naphthenic oils, and tackifying resins. The amounts vary depending on the particular application.

### Engineering Thermoplastic Resins

In some embodiments of the present invention, and as noted above, the hybrid block copolymer compositions can be prepared with engineering thermoplastics. For the purposes of this specification and claims, the term “engineering thermoplastic resin” or ETP encompasses the various polymers found in the classes listed in Table A below, and further defined in Part C Table A 2-8 of U.S. Pat. No. 4,107,131, and furthermore, the disclosure of Table A, 2-8 and Part C, 2-8, namely, Col. 6, lines 56-59 and Col. 8, line 65 to Col. 20, line 2 of U.S. Pat. No. 4,107,131 is hereby incorporated by reference.

TABLE A

Thermoplastic Polyester
Thermoplastic Polyurethane
Poly(aryl ether) and Poly(aryl sulfone)
Polycarbonate
Acetal resin
Polyamide
Halogenated thermoplastic
Nitrile barrier resin
Acrylic polymers including poly(alky
methacrylates) and poly(alkyl acrylates) such as
poly(methyl methacrylate) and poly(ethyl
methacrylate)
Cyclic olefin copolymers

As noted above, thermoplastic polyurethane (“TPU”) elastomers are one of the engineering thermoplastic resins which can be used according to some of the embodiments of the present invention. TPUs are generally made from long chain diols, chain extenders and polyisocyanates. The properties are achieved by phase separation of soft and hard segments. The hard segment, formed by, for example, adding butanediol to the diisocyanate, provides mechanical strength and high temperature performance. The soft segment, consisting of long flexible polyether or polyester chains with molecular weight of 600 to 4000, controls low temperature properties, solvent resistance and weather resistance.

Urethane based thermoplastic elastomers have an impressive range of performance characteristics such as outstanding scratch/abrasion resistance, excellent oil resistance and high tensile/tear strength. TPU can be processed by injection molding, blown film, extrusion, blow molding and calendaring. It is used in a broad range of applications such as films and sheets, athletic equipment, hoses/tubing, medical devices and automotive molded parts. However, application of TPU is limited when low hardness (<70 A) is required, such as applications when soft touch is required. It is difficult to produce soft grade TPU materials without adding plasticizers, which are not desirable in some applications.

Others have proposed various blends of TPU with other polymers. U.S. Pat. No. 3,272,890 discloses blends of 15 to 25 weight percent of polyurethane in polyethylene. This is achieved by first melting and fluxing the polyethylene in a Banbury mixer to which is added the polyurethane. In a series of U.S. Pat. Nos. 3,310,604; 3,351,676; and 3,358,052, there is disclosed polyurethanes having dispersed therein 0.2 to 5 weight percent polyethylene. U.S. Pat. No. 3,929,928 teaches that blends of 80:20 to 20:80 weight ratio of chlorinated polyethylenes with polyurethanes and containing 1 to 10 pph of polyethylene result in improved processability, particularly in the manufacture of films or sheets by milling or calendering. Such blends are more economical than the polyurethane alone. U.S. Pat. Nos. 4,410,595 and 4,423,185 disclose soft resinous compositions containing 5 to 70 weight percent thermoplastic polyurethanes and 30 to 95 percent of polyolefins modified with functional groups such as carboxyl, carboxylic acid anhydride, carboxylate salt, hydroxyl, and epoxy. One of the features of the disclosed blends is their adhesion to other polymeric substances such as polyvinyl chloride, acrylic resins, polystyrenes, polyacrylonitriles, and the like. This property leads to their prime utility in the coextrusion, extrusion coating, extrusion laminating, and the like of polymer laminates. U.S. Pat. No. 4,883,837 discloses thermoplastic compatible compositions comprising (A) a polyolefin, (B) a thermoplastic polyurethane, and a compatibilizing amount of (C) at least one modified polyolefin. U.S. Pat. No. 4,088,627 discloses multicomponent blends of thermoplastic polyurethane, a selectively hydrogenated styrene/diene block copolymer and at least one dissimilar engineering thermoplastic. U.S. Pat. No. 7,030,189 discloses blends of a thermoplastic polyurethane, a polar group-containing thermoplastic elastomer and another thermoplastic elastomer.

Some of the embodiments of the present invention include blends of a thermoplastic polyurethane elastomer, a styrenic block copolymer and a novel hybrid block copolymer. It is has been found by the inventors herein that the hybrid block copolymers are an excellent compatibilizer and significantly improves physical properties of TPU blends.

Polyphenylene ether (“PPE”) polymers are another engineering thermoplastic resin suitable for use according to the present invention and are produced by techniques well known in the art such as by oxidizing a phenol with an oxygen-containing gas in the presence of a catalyst system comprising a cuprous salt and a tertiary amine. Suitable PPE's are homo- and copolymers with repeating para-phenylene or substituted para-phenylene units having from 1 to 4 pendent groups which are independently selected from the group consisting of halogen radicals, hydrocarbon radicals, halohydrocarbon radicals having at least two carbon atoms between the halogen atom and the phenol nucleus, hydrocarbonoxy radicals, and halohydrocarbonoxy radicals having at least two carbon atoms between the halogen atom and the phenol nucleus.

PPE is blended with other materials to improve performance. Addition of polystyrene to PPE lowers the glass transition temperature and improves processability and cost. Furthermore, addition of a crystalline plastic such as a polyamide or polyester or polyolefin improves the resistance of PPE to solvents, fluids, gasoline, oils and the like. Fillers and fibers including mineral fillers and glass or carbon fibers are often added to PPE based systems to increase stiffness and heat resistance. Styrenic block copolymers can be added to PPE based systems to increase impact strength and to improve the balance of stiffness, ductility, and heat resistance. US Patent Application 2007/0276082 discloses compositions comprising the product obtained on melt-kneading a poly(arylene ether), an acid-functionalized block copolymer of an alkenyl aromatic monomer and a conjugated diene and a polyamine compound. In this application the acid-functionalized block copolymers are made by free-radical grafting and the polyamine is used for crosslinking. U.S. Pat. Nos. 7,182,886; 5,723,539; 4,873,286 disclose compositions in which PPE is combined with crystalline engineering plastics such as polyamides, non-functionalized block copolymers, fillers, fibers, and non-polymeric compatibilizers.

The hybrid block copolymers of the current invention have good compatibility in PPE based compositions and additionally provide added benefits including improved adhesion and reactivity with polar plastics such as polyamides and polyesters, improved adhesion to fillers and fibers including glass fibers, carbon fibers, carbon black, and clays, and an improvement of the composition surface properties including improved adhesion to polar substrates and plastics and enhanced paintability.

Furthermore, polyamide polymers are another engineering thermoplastic resin suitable for use according to the present invention. Some particular polyamides may include polyhexamethylene adipamide (nylon 6,6), polyhexamethylene sebacamide (nylon 6,10), polycaprolactam (nylon 6), polyhexamethylene terephthalamide, polyhexamethylene isophthalamide, and polyhexamethylene tere-co-isophthalamide.

The hybrid block copolymer compositions of the present invention may also contain conventional styrene/diene and hydrogenated styrene/diene block copolymers, such as the block copolymers available from Kraton Polymers and Septon Company of America. These block copolymers include linear S-B-S, S-I-S, S-EB-S, S-EP-S, S-EEP-S block copolymers. Also included are radial block copolymers based on styrene along with isoprene and/or butadiene and selectively hydrogenated radial block copolymers.

Olefin polymers include, for example, ethylene homopolymers, ethylene/alpha-olefin copolymers, propylene homopolymers, propylene/alpha-olefin copolymers, high impact polypropylene, butylene homopolymers, butylene/alpha olefin copolymers, and other alpha olefin copolymers or interpolymers. Representative polyolefins include, for example, but are not limited to, substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE) and high pressure low density polyethylene (LDPE). Other polymers included hereunder are ethylene/acrylic acid (EEA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, polypropylene homopolymers and copolymers, propylene/styrene copolymers, ethylene/propylene copolymers, polybutylene, ethylene carbon monoxide interpolymers for example, ethylene/carbon monoxide (ECO) copolymer, ethylene/acrylic acid/carbon monoxide terpolymer and the like. Still other polymers included hereunder are polyvinyl chloride (PVC) and blends of PVC with other materials.

Styrene polymers include, for example, crystal polystyrene, high impact polystyrene, medium impact polystyrene, styrene/acrylonitrile copolymers, styrene/acrylonitrile/butadiene (ABS) polymers, syndiotactic polystyrene, styrene/methyl-methacrylate copolymers and styrene/olefin copolymers. Representative styrene/olefin copolymers are substantially random ethylene/styrene copolymers, preferably containing at least 10, more preferably equal to or greater than 25 weight percent copolymerized styrene monomer. Also included are styrene-grafted polypropylene polymers, such as those offered under the tradename Interloy® polymers, originally developed by Himont, Inc. (now Basell).

Tackifying resins include polystyrene block compatible resins and midblock compatible resins. The polystyrene block compatible resin may be selected from the group of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “ENDEX”, “KRISTALEX”, “NEVCHEM” and “PICCOTEX”. Resins compatible with the (mid) block may be selected from the group consisting of compatible C5 hydrocarbon resins, hydrogenated C5 hydrocarbon resins, styrenated C5 resins, C5/C9 resins, styrenated terpene resins, fully hydrogenated or partially hydrogenated C9 hydrocarbon resins, rosins esters, rosins derivatives and mixtures thereof. These resins are e.g. sold under the trademarks “REGALITE”, “REGALREZ”, “ESCOREZ” and “ARKON”.

Another one of the components used in the hybrid block copolymer compositions of the present invention is a polymer extending oil or plasticizer. Especially preferred are the types of oils that are compatible with the elastomeric segment of the hybrid block copolymer and conventional styrene block copolymer. While oils of higher aromatics content are satisfactory, those petroleum-based white oils having low volatility and less than 50% aromatic content are preferred. Such oils include both paraffinic and naphthenic oils. The oils should additionally have low volatility, preferable having an initial boiling point above about 500° F.

Examples of alternative plasticizers which may be used in the present invention are oligomers of randomly or sequentially polymerized styrene and conjugated diene, oligomers of conjugated diene, such as butadiene or isoprene, liquid polybutene-1, and ethylene-propylene-diene rubber, all having a weight average molecular weight in the range from 300 to 35,000, preferable less than about 25,000 mol weight.

The amount of oil or plasticizer employed varies from about 0 to about 300 parts by weight per hundred parts by weight rubber, or block copolymer, preferably about 20 to about 150 parts by weight.

Plasticizers include paraffinic and naphthenic oils. While oils of higher aromatics content are satisfactory, those petroleum-based white oils having low volatility and less than 50% aromatic content are preferred. Typical paraffinic processing oils can be used to soften and extend polymers of the present invention; however, processing oils with a higher naphthenic content are more compatible with the controlled distribution rubber block. Processing oils with a naphthenic content between 40% and 55% and an aromatic content less than 10% are preferred. The oils should additionally have low volatility, preferable having an initial boiling point above about 500° F.

Regarding the relative amounts of the various ingredients, this will depend in part upon the particular end use and on the particular block copolymer that is selected for the particular end use.

The compositions of the hybrid block copolymers with engineering thermoplastic resin and other ingredients, including plasticizers, can be used to make materials having a hardness less than 60 shore D, more preferably less than 95 shore A, and most preferably 10-70 shore A. The ASTM D2240 shore A and D scales are well known to those of skill in the art.

### Compositions Comprising Fillers, Fibers, Pigments, Flame Retardants and the Novel Hybrid Block Copolymer

The polymer blends of the present invention may be compounded further with other fillers, pigments, reinforcements, antioxidants, stabilizers, fire retardants, antiblocking agents, lubricants and other rubber and plastic compounding ingredients without departing from the scope of this invention. The hybrid block copolymers are effective dispersants for these additional particles adding to the compatibilization thereof.

Examples of fillers are found in the 1971-1972 Modern Plastics Encyclopedia, pages 240-247. Particulate fillers and fibers are also discussed in 1974 Mechanical Properties of Polymers Volume 2 pages 379-510. Composite materials comprising polymers and particulate fillers and fibers are used for several reasons including improved stiffness, strength, dimensional stability, higher heat distortion temperature and often increased toughness and impact strength. Most reinforcing materials such as fillers and fibers are inorganic or organic products of high molecular weight. Fillers and fibers include mineral, natural or synthetic products. Various examples include calcium carbonate, talc, silica, clays, glass fibers, asbestos, boron fibers, carbon and graphite fibers, whiskers, quartz and silica fibers, ceramic fibers, metal fibers, natural organic fibers, synthetic organic fibers, glass beads, polymeric beads, hollow beads, nano fillers, titanium dioxide, carbon black, organo clays, cotton fibers, rockwool fibers, wood chips, scrap from the wood and paper industry, cellulose fibers, and the like. Coupling agents, such as various silanes, may be employed in the preparation of the reinforced blends.

Suitable pigments are pigment particles capable of being dispersed by the hybrid block copolymers. Many suitable pigments are known that are of different colors, particle sizes, compositions (e.g. organic or inorganic), surface characteristics, etc. Colors of pigment particles include, for example, black, cyan, yellow, magenta, red and green. These colors are typical, but any other color of pigment particles may be used as well.

The pigment particles are preferred to be of a size sufficiently small to allow free flow of particles during processing. For example, in ink jettable inks, the particles are small enough to allow free flow through ink jet printing devices, especially at the nozzle. As for pigment particle size distribution, narrower size distributions are generally preferred.

Pigments useful in the invention may be organic or inorganic. Suitable inorganic pigments include, but are not limited to, carbon black and titanium dioxide, while suitable organic pigments include, but are not limited to, phthalocyanines, antrhraquinones, perylenes, carbozoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, and anthrapyrimidines. It will be recognized by those skilled in the art that organic pigments are differently shaded, or even have different colors, depending on the functional groups attached to the main molecule.

Commercial examples of useful organic pigments include, but are not limited to, those described in The Colour Index, Vols. 1-8, Society of Dyers and Colourists, Yorkshire, England having the designations Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24, and Pigment Blue 60 (blue pigments); Pigment Brown 5, Pigment Brown 23, and Pigment Brown 25 (brown pigments); Pigment Yellow 3, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 108, Pigment Yellow 109, Pigment Yellow 110, Pigment Yellow 113, Pigment Yellow 128, Pigment Yellow 129, Pigment Yellow 138, Pigment Yellow 139, Pigment Yellow 150, Pigment Yellow 154, Pigment Yellow 156, and Pigment Yellow 175 (yellow pigments); Pigment Green 1, Pigment Green 7, Pigment Green 10, and Pigment Green 36 (green pigments); Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60, and Pigment Orange 61 (orange pigments); Pigment Red 4, Pigment Red 5, Pigment Red 7, Pigment Red 9, Pigment Red 22, Pigment Red 23, Pigment Red 48, Pigment Red 48:2, Pigment Red 49, Pigment Red 112, Pigment Red 122, Pigment Red 123, Pigment Red 149, Pigment Red 166, Pigment Red 168, Pigment Red 170, Pigment Red 177, Pigment Red 179, Pigment Red 190, Pigment Red 202, Pigment Red 206, Pigment Red 207, and Pigment Red 224 (red pigments); Pigment Violet 19, Pigment Violet 23, Pigment Violet 37, Pigment Violet 32, and Pigment Violet 42 (violet pigments); and Pigment Black 6 or 7 (black pigments).

The hybrid block copolymers are effective dispersants for a variety of compositions and applications including printing inks, paints, coatings, paper production, ceramics, pesticides, cooling and boiler water, dyestuffs, gypsum board, latex polymers and concrete, plastics, rubbery polymeric compositions, flexible polymeric compositions, adhesives, sealants, coatings, film, optical film, styrenic block copolymer compositions, styrenic polymer compositions, polyolefin polymer compositions, PPE compositions, printing plates and the like.

The percentage of reinforcing particles including fillers and fibers, pigment particles, and flame retardents in a composition depends upon the application. For example, with inks, the weight percentage of the pigment is about 1% to about 15%. For example, with black rubbery compositions used for injection molding and extrusion the weight percentage of the pigment carbon black is about 0.5% to about 5%. For example, in low smoke non-halogen flame retardant rubbery compounds the weight percentage level of filler can be as high as 50-80%.

The hybrid block copolymers are effective compatibilizers and dispersants for a variety of compositions and applications including plastics, rubbery polymeric compositions, flexible polymeric compositions, film, styrenic block copolymer compositions, styrenic polymer compositions, polyolefin polymer compositions, PPE compositions, and the like.

### Applications for Hybrid Polymers

Table B below shows some notional compositions expressed in percent weight, which are included in the present invention. The more preferred ranges are also provided for certain of the compositions. For the “Polymer” amount, a portion may include conventional styrene block copolymers. The portion of polymer that includes conventional styrene block copolymer will depend on the application. Such portion may contain from 0-99%, preferably 0-90% and most preferably 0-75% of conventional styrene block copolymers as part of the total “Polymer” amount added:

TABLE B
Applications, Compositions and Ranges

| Application | Ingredients | Composition % w. |
|---|---|---|
| Films, Molding, Alloys | Polymer | 1-99% |
| | Ethylene copolymers:EVA, | 99-1% |
| | Ethylene/styrene | |
| Personal Hygiene Films and Fibers | Polymer | 10-90% |
| | PE or PE wax | 0-30%, 1-25% |
| | PP | 0-30%, 1-25% |
| | Tackifying Resin | 5-30% |
| | End Block Resin | 0-20% |
| Personal Hygiene Films and Fibers | Polymer | 10-90% |
| | PS | 0-50%, 1-25 |
| | Oil | 0-50%, 1-25% |
| | Tackifying Resin | 0-30%, 5-30% |
| Injection Molded/Extruded articles 1 | Polymer | 25-100%, 30-85%, 35-75% |
| | Polyolefin | 0-50%, 1-50%, 5-45% |
| | PS | 0-50%, 1-50%, 5-45% |
| | Oil | 0-50%, 1-50%, 5-45% |
| | Filler | 0-50%, 1-50%, 5-45% |
| Injection Molded/Extruded article 2 | Polymer | 25-100%, 30-85% |
| | Engineering Plastic | 0-50%, 1-50%, 5-45% |
| | Polyolefin | 0-50%, 1-50%, 5-45% |
| | Oil | 0-50%, 1-50%, 5-45% |
| | Filler | 0-50%, 1-50%, 5-45% |
| Injection Molded/Extruded article 3 | Polymer | 25-100%, 35-85% |
| | PPE | 0-50%, 1-50%, 5-45% |
| | PS | 0-50%, 1-50%, 5-45% |
| | Engineering Plastic | 0-50%, 1-50%, 5-45% |
| | Filler | 0-50%, 1-50%, 5-45% |
| | Oil | 0-50%, 1-50%, 5-45% |
| Injection Molded/Extruded article 4 | Polymer | 20-70%, 25-65%, 35-60% |
| | PMMA/PEMA | 30-80%, 35-75%, 40-70% |
| | Oil | 0-50%, 1-50%, 5-45% |
| Compatibilization/Recycling of | Polymer | 1-20% |
| Commingled Plastics | Polyethylene | 0-70%, 1-65%, 5-80% |
| | Polypropylene | 0-70%, 1-65%, 5-80% |
| | Polystyrene | 0-70%, 1-65%, 5-80% |
| | Polymethylmethacrylate | 0-70%, 1-65%, 5-80% |
| | Polyvinylchloride | 0-20%, 1-20% |
| Cap Seals | Polymer | 25-60% |
| | Oil | 0-50%, 1-50%, 5-45% |
| | PP and/or Tackifying Resin | 0-50%, 1-50%, 5-45% |
| | Filler | 0-25%, 1-25%, 5-20% |
| | Lubricant | 0 to 3% |
| Engineering Thermoplastic toughening | Polymer | 1-30%, 5-25%, 10-20% |
| | Engineering Plastic | 70-95%, 75-92%, 80-90% |
| Dipped Goods | Polymer | 60-100% |
| | Plasticizer, oil | 0-40% |
| Packaging/Barrier Film | Polymer | 5-50%, 10-45%, 15-40% |
| | Engineering Plastic | 50-95%, 55-90%, 60-80% |
| | EVA | 0-50%, 1-50%, 5-45% |
| Polymer Modification | Polymer | 5-95% |
| | ABS, PS, HIPS, Cyclic olefin | 95-5% |
| | copolymers | |

The polymer of the present invention may be used in a large number of applications, either as a neat polymer or in a compound. The following various end uses and/or processes are meant to be illustrative, and not limiting to the present invention:
Polymer modification applications
Injection molding of toys, medical devices
Extruding films, tubing, profiles
Over molding applications for personal care, grips, soft touch applications, for automotive parts, such as airbags, steering wheels, etc
Dipped goods, such as gloves
Thermoset applications, such as in sheet molding compounds or bulk molding compounds for trays
Roto molding for toys and other articles
Slush molding of automotive skins
Thermal spraying for coatings
Blown film for medical devices
Transparent tubing for medical purposes having improved kink resistance
Blow molding for automotive/industrial parts
Films and fibers for personal hygiene applications
Foamed formulations for weight reduction
Tie layers

### Overmolding Applications

Moreover, according to some embodiments of the present invention, hybrid block copolymers may be used in overmolding applications. Generally, hydrogenated styrenic block copolymer formulated compounds are used for overmolding onto rigid substrates to provide a soft-touch feel and tailored appearance. Such hydrogenated styrenic block copolymers generally have a diene midblock, including for instance S-EB-S, S-EP-S, S-EEP-S block copolymers. Ease of colorability and processability make styrenic block copolymers highly suitable for overmolded applications. Examples of rigid substrates include polypropylene (PP), polyethylene (PE), acrylonitrile/butadiene/styrene (ABS), polycarbonate (PC), polyamides (PA), polyesters, etc. It can be especially difficult to achieve good adhesion to many ETP substrates with HSBC compounds of with durometers less than 70 Shore A.

Overmold adhesion is dictated by both wettability and polarity/compatibility of the overmold material with the substrate. Low formulation viscosity primarily drives wetting which facilitates fast and complete coverage. Oils are often used to reduce viscosity in order to promote wetting at the surface. However, too much oil can be detrimental to adhesion. Other flow promoters can also be used to promote interfacial wetting without such detrimental effects on adhesion. Compatibility between the overmold material and the substrate is also critical to the development of optimal adhesion. Increasing the polarity of the overmold formulation or of the HSBC itself can lead to improved compatibility. Maleated HSBCs or maleated polyolefins have been used to improve polarity at the surface to promote adhesion. However, the commercial acid-functionalized block copolymers have several deficiencies because of their small styrene block size and low molecular weight by products of the free radical process which hurt mechanical properties and service temperature. The polar and reactive hybrid block copolymers of the present invention are made by anionic polymerization rather than free radical processes and so can be tailored to a specific molecular weight, functionality content, and furthermore do not contain low molecular weight by-products of the free radical process.

Therefore, the hybrid block copolymers of the present invention can be used for overmolding with the rigid substrates such as those mentioned above. In preferred embodiments, the rigid substrate would be a polar thermoplastic, and still more preferred polycarbonate, polyamide, ABS, polycarbonate/ABS blends, poly(methylmethacrylate), poly(methylmethacrylate)/ABS blends, and polyesters.

### EXAMPLES

The following examples are provided to illustrate the present invention. The examples are not intended to limit the scope of the present invention and they should not be so interpreted. Amounts are in weight parts or weight percentages unless otherwise indicated.

### Working Example 1

Preparation of Block Copolymers Hybrid Polymer 1, Hybrid Polymer 2, Hybrid Polymer 3

Hybrid Polymer 1 (“HB1”) was polymerized in the solvent mixture comprising 90% cyclohexane and 10% diethyl ether. Styrene was polymerized in the step I reactor and the living polymer was transferred to the step II reactor for sequential polymerization of butadiene followed by tert-butyl methacrylate (“TBMA”). The polymerization was terminated with methanol. 1.61 kg of TBMA and 37.5 kg of total monomer were charged for a target polymer TBMA content of 4.3% wt. The peak molecular weights in polystyrene equivalents were characterized by GPC with UV detector at each step: 7,054 after styrene polymerization, 122,425 after BD polymerization, and a mixture of 67% of a material with 127,043 molecular weight and 33% of a species with 250,264 molecular weight after TBMA polymerization. The reaction mixture was analyzed by NMR after TBMA polymerization and shown to contain no unreacted monomer within detection limits. The polymer was hydrogenated with a cobalt catalyst, washed with dilute phosphoric acid, neutralized with ammonia and stabilized with 0.1% Irganox 1010. The hydrogenated polymer cement was analyzed by NMR. The hydrogenated polymer contained 9.5% styrene, a residual unsaturation of 0.12 meq/gm, and a 1,2 BD content of 39.6%. The S-EB-TBMA polymer was recovered by cyclone finishing and dried in an air circulating oven.

HB2 was polymerized in the solvent 90% cyclohexane/10% diethyl ether. Styrene was polymerized in the step I reactor and the living polymer was transferred to the step II reactor for sequential polymerization of butadiene followed by TBMA. The polymerization was terminated with methanol. 3.08 kg of TBMA and 37.5 kg of total monomer were charged for a target polymer TBMA content of 8.2% wt. The peak molecular weights in polystyrene equivalents were characterized by GPC with UV detector at each step: 7,117 after styrene polymerization, 127,360 after BD polymerization, and a mixture of 66% of a material with 130,562 molecular weight and 34% of a species with 256,135 molecular weight after TBMA polymerization. The reaction mixture was analyzed by NMR after TBMA polymerization and shown to contain no unreacted monomer within detection limits. The polymer was hydrogenated with a cobalt catalyst, washed with dilute phosphoric acid, neutralized with ammonia and stabilized with 0.1% Irganox 1010. The hydrogenated polymer cement was analyzed by NMR. The hydrogenated polymer contained 9.2% styrene, a residual unsaturation of 0.20 meq/gm, and a 1,2 BD content of 39.5%. The S-EB-TBMA polymer was recovered by cyclone finishing and dried in an air circulating oven.

HB3 was prepared by sequential polymerization in 90% cyclohexane/10% diethyl ether of 30 kg of butadiene followed by 7.5 kg of TBMA. The polymerization was terminated with methanol. The target polymer TBMA content was 20%. The peak molecular weights in polystyrene equivalents were characterized by GPC with refractive index detector at each step: 113,106 after BD polymerization and a mixture of 62% of a material with 116,479 molecular weight and 38% of a species with 226,980 molecular weight after TBMA polymerization. The polymer was hydrogenated with a cobalt catalyst, washed with dilute phosphoric acid, neutralized with ammonia and stabilized with 0.1% Irganox 1010. The EB-TBMA polymer was recovered by hot water coagulation.

Conversion of Block Copolymers to Anhydride Form

The polymers were converted to the anhydride/acid form by extruding with a Berstoff 25 mm twin screw co-rotating extruder. Two examples are given below:

TABLE 1
Extruder Conditions

| | HB1A | HB1B |
|---|---|---|
| Actual temperature ° C. | | |
| Zone 1 | 250 | 220 |
| Zone 2 | 250 | 220 |
| Zone 3 | 255 | 225 |
| Zone 4 | 255 | 225 |
| Zone 5 | 260 | 230 |
| Zone 6 | 260 | 230 |
| Zone 7 | 260 | 230 |
| Extruder speed rpm | 200 | 198 |

IR spectroscopy showed that the S-EB-GA polymers were substantially converted from the TBMA ester to the TBMA anhydride form. HB1 has an IR absorption peak at about 1726 cm⁻¹ which is characteristic of the ester group. After extrusion, HB1A and HB1B have virtually no peak at 1726 cm⁻¹ and have IR absorption peaks at about 1800 cm⁻¹ and 1760 cm⁻¹. These are characteristic peaks for the anhydride group.

### Working Example 2

Compositions Comprising PPE and the Hybrid Block Copolymers

The following hybrid block copolymers were prepared

TABLE 2

| Polymer | Target Structure | Form |
|---|---|---|
| HB4 | S20-TBMA20 | Ester |
| HB5 | S20-TBMA3 | Ester |
| HB6 | S20-BD30-TBMA2 | Ester, hydrogenated |
| HB6 extruded | S20-BD30-GA | Anhydride, hydrogenated |
| HB1 | S7-BD60-TBMA3 | Ester, hydrogenated |
| HB1 extruded | S7-BD60-GA | Anhydride, hydrogenated |
| HB7 | S7-BD33-S5-TBMA2 | Ester, hydrogenated |
| HB7 extruded | S7-BD33-S5-GA | Anhydride, hydrogenated |
| HB8 | S50-TBMA50 | Ester |
| HB9 | S5-BD50-TBMA2 | Ester, hydrogenated |

Here the target block molecular weights are in 1000's, so that an S20-TBMA20 has a polystyrene block of 20,000 and a TBMA block of 20,000. Here the molecular weights are true molecular weights.

These polymers were blended with PPE and other formulating ingredients.

A pre-blend of PPE and Kraton G 1701 Rubber was made on a 25 mm co-rotating twin screw extruder at a 5:1 weight ratio of PPE and G1701. This pre-blend was then blended with nylon 66 and a hybrid block polymer at 0, 2 and 5% wt to make formulations which contained a weight ratio of nylon 66:PPE:G1701 of 40:50:10. ⅛^{th} inch thick samples were injection molded. The properties of the molded samples are shown in the following table:

TABLE 3

| | % wt | RT N Izod | Flex Mod | TS* | | HDT@264 psi |
|---|---|---|---|---|---|---|
| Polymer | Polymer | Ft lb/in | Mpsi | psi | EB % | ° C. |
| None | 0 | 0.55 | 262 | 7330 | 3.1 | 147 |
| HB5 | 2 | 0.64 | 284 | 7890 | 3.1 | 155 |
| HB5 | 5 | 0.68 | 307 | 9660 | 4.0 | 157 |
| HB4 | 2 | 0.45 | 294 | 8380 | 3.1 | 160 |
| HB4 | 5 | 0.75 | 308 | 9300 | 3.5 | 160 |

*TS = Tensile strength

Addition of hybrid block polymers to compositions which comprise PPE and nylon 6,6 improves the physical properties. Without being bound to a particular theory, it is believed that hybrid polymers in the acid and anhydride form react with the nylon 6,6 amine end-groups, and hybrid polymers in the ester form convert to the anhydride form during melt blending. In this particular formulation, some of the hybrid polymers HB5 and HB4 were found to reside in the nylon 6,6 phase and caused an increase in the size and continuity of the PPE phase. The hybrid block polymers should have a styrene block molecular weight of at least about 2000 so that they are compatible in PPE systems and must contain on average at least one TBMA unit in the TBMA block so that they can react with the nylon 6,6. The hybrid block polymers contain at least one styrene block and one terminal TBMA block, optionally a block of a polymerized, hydrogenated butadiene having at least some 1,2-enchainments, optionally a block of polymerized, hydrogenated isoprene, optionally a block of polymerized, hydrogenated isoprene and butadiene, and optionally a block of polymerized styrene and butadiene.

The PPE/Kraton G1701 Rubber pre-blend was compounded with polybutylene terephthalate (PBT) and the hybrid block polymers at 0, 2 and 5% wt to make formulations which contained a weight ratio of PBT:PPE:G1701 of 40:50:10. ⅛^{th} inch thick samples were injection molded. The properties of the molded samples are shown in the following table:

TABLE 4

| | % wt | RT N Izod | Flex Mod | TS | | HDT@264 psi |
|---|---|---|---|---|---|---|
| Polymer | Polymer | Ft lb/in | Mpsi | psi | EB % | ° C. |
| None | 0 | 0.25 | 316 | 4250 | 1.5 | 137 |
| HB5 | 2 | 0.30 | 325 | 4860 | 1.7 | 141 |
| HB5 | 5 | 0.61 | 333 | 7000 | 2.6 | 145 |
| HB4 | 2 | 0.28 | 314 | 5100 | 1.8 | 145 |
| HB4 | 5 | 0.32 | 329 | 5670 | 2.0 | 144 |
| HB8 | 2 | 0.25 | 323 | 5210 | 1.8 | 140 |
| HB8 | 5 | 0.25 | 328 | 5550 | 1.9 | 139 |

Addition of hybrid block polymers to compositions which comprise PPE and thermoplastic polyesters such as PBT and PET improves the physical properties. Without being bound to a particular theory, it is believed that hybrid polymers in the acid and anhydride form react with the polyester hydroxyl end-groups, and hybrid polymers in the ester form convert to the anhydride form during melt blending. In these particular PBT formulations, the addition of hybrid block polymer reduced the PBT phase size while maintaining the continuity of the PPE phase. It can be assumed basis the change in morphology that the hybrid polymer reacts with the PBT, interacts strongly with the PPE, and some of the hybrid polymer resides at the interface. The hybrid block polymers should have a styrene block molecular weight of at least about 2000 so that they are compatible in PPE systems and must contain on average at least one TBMA unit in the TBMA block so that they can react with the polyester. The hybrid block polymers contain at least one styrene block and one terminal TBMA block, optionally a block of a polymerized, hydrogenated butadiene having at least some 1,2-enchainments, optionally a block of polymerized, hydrogenated isoprene, optionally a block of polymerized, hydrogenated isoprene and butadiene, and optionally a block of polymerized styrene and butadiene.

The PPE/Kraton G1701 Rubber pre-blend was compounded with nylon 6 and the hybrid block polymers at 0, 2 and 5% wt to make formulations which contained a weight ratio of nylon 6:PPE:G1701 of 40:50:10. ⅛^{th} inch thick samples were injection molded. The properties of the molded samples are shown in the following table:

TABLE 5

| | % wt | RT N Izod | Flex Mod | TS | | HDT@264 psi |
|---|---|---|---|---|---|---|
| Polymer | Polymer | Ft lb/in | Mpsi | psi | EB % | ° C. |
| None | 0 | 0.54 | 247 | 7770 | 3.2 | 147 |
| HB4 | 2 | 1.26 | 265 | 9130 | 5.1 | 154 |
| HB4 | 5 | 1.44 | 284 | 8420 | 13.4 | 153 |
| HB5 | 2 | 1.00 | 252 | 7750 | 3.7 | 150 |
| HB5 | 5 | 1.60 | 269 | 8430 | 6.3 | 149 |

Addition of hybrid block polymers to compositions which comprise PPE and nylon 6 improves the physical properties. Without being bound to a particular theory, it is believed that hybrid polymers in the acid and anhydride form react with the nylon 6 amine end-groups, and hybrid polymers in the ester form convert to the anhydride form during melt blending. In this particular formulation, some of the hybrid polymer was found to reside in the nylon 6 phase. Also addition of hybrid block polymers can cause a decrease in the PPE phase size which indicates that the hybrid polymer is acting as an interfacial agent i.e., a compatibilizer. The hybrid block polymers should have a styrene block molecular weight of at least about 2000 so that they are compatible in PPE systems and must contain on average at least one TBMA unit in the TBMA block so that they can react with the nylon 6. The hybrid block polymers contain at least one styrene block and one terminal TBMA block, optionally a block of a polymerized, hydrogenated butadiene having at least some 1,2-enchainments, optionally a block of polymerized, hydrogenated isoprene, optionally a block of polymerized, hydrogenated isoprene and butadiene, and optionally a block of polymerized styrene and butadiene.

### Prophetic Example 3

Compositions Comprising Fillers, or Fibers, Pigments, and the Novel Hybrid Block Copolymer

A pre-blend of PPE and Kraton G 1701 Rubber was made on a 25 mm co-rotating twin screw extruder at a 5:1 weight ratio of PPE and G1701. This pre-blend was then blended with nylon 66, a hybrid block polymer at 0, 0.5, 1, 2 and 5% wt and either 10 micron diameter ¼ inch long chopped glass fibers sized with an amino silane, carbon black, or a clay to make compounds which contained a weight ratio of nylon 66: PPE: G1701 of 40:50:10 and contained 5-50% wt of the glass fibers or carbon black or clay. The compounds were injection molded and physical properties measured. The compounds exhibited an excellent balance of stiffness, impact resistance and heat distortion temperature. Addition of the hybrid block polymer improved the impact resistance without significantly reducing stiffness and heat distortion temperature. The best results with glass fibers were obtained when they were added to the extruder after the other ingredients were already mixed and so that the extruder mixing elements had low intensity once the glass fibers were added.

### Prophetic Example 4

Composition Comprising Flame Retardant and the Novel Hybrid Block Copolymer

A compound was made on a twin screw extruder which contained 60 parts of G1651, a commercial high molecular weight hydrogenated SEBS polymer, 40 parts of a hybrid block polymer with structure S(30,0000)-EB(150,000)-TBMA glutaric anhydride form(1,500) where the numbers in pararentheses are block true molecular weights, 25 parts of a hydrocarbon extending oil Drakeol 34, 30 parts of a 30 melt flow homopolypropylene from Sun-Allomer, and 50 parts of hydrated inorganic filler aluminum trihydrate Hydral 710 from Alcoa. This compound exhibited excellent flame retardency in the UL94V test. A similar compound was also made which used Kisuma 5B, a magnesium hydroxide from Kyowa Chemical, instead of the aluminum trihydrate. This compound also exhibited excellent flame retardency.

### Working Example 5

Soft Rubbery Compositions Comprising Novel Hybrid Block Copolymer and Polar Polymers Including Engineering Thermoplastics.

The Table below demonstrates the use of hybrid block copolymers to make soft and transparent compound formulations. All compositions are given in parts per hundred rubber (phr) and all formulations contain an additional 0.2 phr phenolic antioxidant. Formulations were melt mixed in a batch mixer with a melt temperature of 200° C. The hybrid block copolymer in Formulation 1 exhibited significantly improved mixing characteristics as compared to Formulation 2 and 3 based on traditional SEBS (G1652) and free radical maleic anhydride grafted SEBS polymers (FG1901). After melt mixing, compression molded samples were prepared at 200° C. for hardness, tensile testing, and solvent welding experiments. Solvent welding was tested by dipping the edge of two compression molded plaques into cyclohexanone and overlapping each other by approximately one inch. The solvent was allowed to evaporate and bond strength was evaluated for integrity.

The hybrid block copolymer in Formulation 1 demonstrated more uniform mixing and dispersion of the PMMA as compared with Formulations 2 and 3. The improved mixing and compatibility is also evident by the significantly higher tensile strength and elongation of Formulation 1. In addition to having improved compatibility with PMMA, Formulation 1 based on the hybrid block copolymer is also transparent and solvent weldable with cyclohexanone.

TABLE 6

| | Formulation | | |
|---|---|---|---|
| | 1 | 2 | 3 |
| Hybrid polymer (HB7 extruded) | 100 | | |
| Kraton G1652 (hydrogenated | | 100 | 50 |
| SBS with about 30% polystyrene | | | |
| content) | | | |
| Kraton FG1901 (hydrogenated | | | 50 |
| SBS with free radical grafted | | | |
| maleic anhydride) | | | |
| Drakeol 34 mineral oil | 100 | 100 | 100 |
| PMMA (Plexiglas V920-UVT) | 50 | 50 | 50 |
| Shore A Hardness, 10s | 36 | 35 | 31 |
| Tensile Strength, psi | 295 | 125 | 125 |
| Elongation, % | 350 | 160 | 225 |
| 100% Modulus, psi | 98 | 110 | 80 |
| Solvent Weldable | Yes | Yes | Yes |
| Transparent | Yes | Yes | Yes |

### Prophetic Example 6

Compatibilization of Polar/Nonpolar Recycle Streams

The Table below demonstrates the use of Hybrid block copolymers for compatibilization of polar/nonpolar polymer streams which could also include commingled recycle streams. The concentrations of ingredients are given in parts per hundred rubber (phr). Formulations 1 and 2 were compounded on a twin screw extruder with a melt temperature of 200° C. The resulting melt strands exhibited good mechanical integrity indicating sufficient compatibilization.

TABLE 7

Formulation

| | 1 | 2 |
|---|---|---|
| Hybrid Polymer (HB7 | 0 | 20 |
| extruded) | | |
| Polystyrene (EA3710) | 25 | 25 |
| LDPE (Attane 4201) | 70 | 70 |
| PMMA (Plexiglas V920-UVT) | 5 | 5 |

### Working Example 7

Stiff (High Modulus) Compositions Comprising Polar Polymers, Including Engineering Thermoplastics, and the Novel Hybrid Block Copolymer

A hybrid polymer HB9 was blended with nylon 6 and Kraton G1657 (a hydrogenated polystyrene-polybutadiene block copolymer with about 13% polystyrene content, and about 30% S-EB diblock and 70% SEBS triblock) in a weight ratio of 80/10/10 of nylon 6/G1657/HB9. This blend had a room temperature ⅛″ notched Izod of 15 ft lb/in and a flexural modulus of 270,000 psi.

Hybrid polymer HB9 was blended with polybutylene terephthalate at a ratio of 80/20 PBT/HB9. This blend had a room temperature ⅛″ notched Izod of 3 ft lb/in and a flexural modulus of 282,000 psi.

### Working Example 8

Compositions Comprising Thermoplastic Polyurethanes and the Novel Hybrid Block Copolymer

The Table below demonstrates the use of hybrid block copolymers as a compatibilizer for other block copolymers and thermoplastic polyurethanes. The resulting compositions have improved physical properties compared to the pure polyurethane.

TABLE 8

| | Estane58132 | | | | |
|---|---|---|---|---|---|
| Ex No | (Control) | TS-88 | TS-89 | TS-90 | TS-91 |
| TPU Estane 58132 | 100 | 60 | 60 | 60 | 60 |
| M-Polymer 1 | | 5 | | | |
| FG1901 (SEBS-graft | | | 5 | | |
| maleic anhydride) | | | | | |
| HB6 extruded | | | | 5 | |
| RP6935 | | 15 | 15 | 15 | 15 |
| Drakeol 34 - mineral oil | | 20 | 20 | 20 | 20 |
| Hardness, Shore A | 83.6 | 64.6 | 64 | 63.2 | 65.9 |
| Tensile Strength psi | | | | | |
| TD | 4082 | 1715 | 2218 | 2352 | 2055 |
| MD | 4059 | 2047 | 2226 | 2036 | 1754 |
| Abrasion, mg/rev | 0.0113 | 0.1827 | 0.265 | 0.0969 | 0.1528 |

Estane 58132 is a polyester based TPU manufactured by Lubrizol.
M-Polymer 1 is a maleic anhydride free radical grafted hydrogenated polymer of structure S-EB/S-S with about 40% polystyrene content. It has an elastomer block which is a controlled distribution copolymer of styrene and hydrogenated butadiene.
RP6935 is a hydrogenated polymer with structure S-EB/S-S with about 60% polystyrene content. It has an elastomer block which is a controlled distribution copolymer of styrene and hydrogenated butadiene.

The experimental results in table 8 above demonstrate that the formulation TS-90 has the best abrasion resistance (lowest abrasion) for the formulations with hardness below 70 shore A.

### Working Example 9

Soft Rubbery Compositions Comprising Novel Hybrid Block Copolymer and Nylon 6,6.

The following compositions were made on a 25 mm co-rotating twin screw extruder using ingredients that were dried prior to processing. The compounds were injection molded and physical properties measured.

| Ingredient, parts by weight | #1 | #2 |
|---|---|---|
| Oiled SEBS (contains 31% | 60 | 45.5 |
| Drakeol 34 mineral oil) | | |
| Drakeol 34 oil | 20 | 24.5 |
| HB7 extruded | | 10 |
| Nylon 6,6-Dupont Zytel 101 | 20 | 20 |
| Irg 1010 | 0.1 | 0.1 |
| Comments | | |
| parts rubber | 41 | 41 |
| parts oil | 39 | 39 |
| parts nylon 6,6 | 20 | 20 |

Properties measured on samples equilibrated in CTH room at 71.5 deg F. and 50% RH.

### Injection Molded Samples 0.12 Inch Thick—ASTM D-2240 for Hardness and ASTM D-412 for Tensiles

Tensiles measured in cross direction.

| | | |
|---|---|---|
| Shore A hardness | 53 | 32 |
| Tensile Stress at Break, psi | 10(*) | 270 |
| 100% Modulus, psi | 120 | 90 |
| 300% Modulus, psi | 130 | 200 |
| % Elongation at Break | 290 | 670 |
| Appearance | has nylon | okay |
| | skin | |

(*)shows a tensile yield at about 10% strain with the skin delaminating

The soft compound containing the conventional styrenic block copolymer plus nylon 6,6 is not compatible in that it has a nylon skin, a low tensile stress at break, and a low elongation at break. The soft compound containing the conventional styrenic block copolymer, nylon 6,6 and the hybrid polymer is compatible in that it did not have a nylon skin and has higher strength and elongation at break.

What is claimed is:

1. An article comprising at least one engineering thermoplastic resin and a hybrid block copolymer, said hybrid block copolymer comprising at least one A block or B block copolymerized with at least one M block, wherein:
(a) the A block is a polymer block of one or more mono alkenyl arenes and the B block is a polymer block of at least one or more conjugated dienes;
(b) the M block is an ester or anhydride polymer block of (1-methyl-1-alkyl)alkyl ester;
(c) the A block having a molecular weight range of from 500 to 40,000, and the B block having a molecular weight range of from 2,000 to 200,000 and the M block having a molecular weight from 200 to 100,000 prior to optional conversion to anhydride form.

2. The article of claim 1 wherein the at least one engineering thermoplastic resin is selected from the group consisting of thermoplastic polyester, thermoplastic polyurethane, poly(aryl ether), poly(aryl sulfone), polycarbonate, acetal resin, polyamide, halogenated thermoplastic, nitrile barrier resin, acrylic polymer, cyclic olefin copolymer, and mixtures thereof.

3. The article of claim 2 wherein the engineering thermoplastic resin comprises poly(aryl ether) and at least one other of said engineering thermoplastic resins.

4. The article of claim 3 wherein the poly(aryl ether) is polyphenylene ether.

5. The article of claim 3 wherein the at least one other engineering thermoplastic resin comprises polyamide.

6. The article of claim 5 wherein the polyamide is selected from the group consisting of polyhexamethylene adipamide (nylon 6,6), polyhexamethylene sebacamide (nylon 6,10), polycaprolactam (nylon 6), polyhexamethylene terephthalamide, polyhexamethylene isophthalamide, polyhexamethylene tere-co-isophthalamide, and mixtures thereof.

7. The article of claim 3 wherein the at least one other engineering thermoplastic resin comprises thermoplastic polyester.

8. The article of claim 2 wherein the at least one engineering thermoplastic resin is thermoplastic polyurethane.

9. The article of claim 2 wherein the at least one engineering thermoplastic is poly(methyl methacrylate).

10. The article of claim 1 wherein the conjugated diene is butadiene or isoprene, the mono alkenyl arene is styrene, and the (1-methyl-1-alkyl)alkyl ester is tert-butyl methacrylate.

11. The article of claim 1 containing from 2-40% of the hybrid block copolymer and from 4-98% of the at least one engineering thermoplastic resin.

12. The article of claim 1 further comprising 5-50 wt % fillers.

13. The article of claim 1 further comprising optionally hydrogenated styrenic block copolymers.

14. The article of claim 1, wherein the article is selected from the group consisting of injection molded/extruded articles, packaging films, barrier films, personal hygiene films and fibers, blown films, coextruded films, tie layers, medical devices, toys, extruded films, extruded tubes, extruded profiles, overmolded grips, overmolded parts, airbags, steering wheels, toys, cap seals, automotive parts, spray coatings, trays, gloves, gaskets, sheets, athletic equipment, and hoses/tubing.

15. The article according to claim 1 wherein the article is in the form of a film, sheet, coating, band, strip, profile, molding, foam, tape, fabric, thread, filament, ribbon, fiber, plurality of fibers or fibrous web.

16. The article according to claim 1 wherein said article is formed in a process selected from the group consisting of injection molding, over molding, dipping, extrusion, roto molding, slush molding, fiber spinning, film making or foaming.

17. The article of claim 1 further comprising an olefin polymer selected from the group consisting of ethylene homopolymers, ethylene/alpha olefin copolymers, ethylene/vinyl aromatic copolymers, propylene homopolymers, propylene/alpha olefin copolymers, propylene/vinyl aromatic copolymers, high impact polypropylene, and ethylene/vinyl acetate copolymers.

18. The article of claim 1 further comprising a styrene polymer selected from the group consisting of crystal polystyrene, high impact polystyrene, medium impact polystyrene, and syndiotactic polystyrene.

19. An article comprising a paraffinic or naphthenic extending oil and a hybrid block copolymer, said hybrid block copolymer comprising at least one A block or B block copolymerized with at least one M block, wherein:
(a) the A block is a polymer block of one or more mono alkenyl arenes and the B block is a polymer block of at least one or more conjugated dienes;
(b) the M block is an ester or anhydride polymer block of (1-methyl-1-alkyl)alkyl ester;
(c) the A block having a molecular weight range of from 500 to 40,000, and the B block having a molecular weight range of from 2,000 to 200,000 and the M block having a molecular weight from 200 to 100,000 prior to optional conversion to anhydride form.

20. The article of claim 19 further comprising at least one engineering thermoplastic resin is selected from the group consisting of thermoplastic polyester, thermoplastic polyurethane, poly(aryl ether), poly(aryl sulfone), polycarbonate, acetal resin, polyamide, halogenated thermoplastic, nitrile barrier resin, acrylic polymer, cyclic olefin copolymer, and mixtures thereof.
